(19) United States
(12) Patent Application Publication
(10) Pub. No.: US 2013/0339677 A1
(43) Pub. Date: Dec. 19, 2013

(54) MULTIPLY-AND-ACCUMULATE OPERATION IN AN IMPLANTABLE MICROCONTROLLER

(71) Applicant: Mattias Tullberg, Uppsala (SE)

(72) Inventor: Mattias Tullberg, Uppsala (SE)

(73) Assignee: ST. JUDE MEDICAL AB, Jarfalla (SE)

(21) Appl. No.: 14/001,867

(22) PCT Filed: Apr. 14, 2011
(86) PCT No.: PCT/EP2011/055963

§ 371 Date: Aug. 27, 2013

(30) Foreign Application Priority Data
Feb. 28, 2011 (EP) PCT/EP2011/052929

(51) Int. Cl. G06F 9/30

(52) U.S. Cl. CPC G06F 9/3001
USPC 712/221

(57) ABSTRACT

The invention provides microprocessor extensions for cooperating with a sequential arithmetic-logic unit (ALU) to execute a multiply-and-accumulate operation (MAc). The ALU performs a continuous sequence of accumulation instructions synchronously with a clock signal (CLK1). Buffers (BUF1, BUF2) store input data which are fed to a combinatorial multiplier (MULT) by first buses (L1, L2). A second bus (N1) forwards the product to the ALU, where it is accumulated with previous data. Since at least the first buses operate independently of the clock signal, they do not limit the speed of the MAc operation. In particular embodiments, a finite state machine (FSM) controls the buses on the basis of triggers, e.g., signals from the multiplier and/or ALU indicating the completion of their respective instructions. The FSM may be operable in a low-power mode. The invention also relates to methods, computer programs and the use of a sequential ALU for executing MAc operations.

### TECHNICAL FIELD

The invention disclosed herein generally relates to an implementation of a multiply-and-accumulate (MAc) operation in a microprocessor that is subject to size and/or power constraints. In particular, the invention provides a MAc implementation suitable for an implantable medical device (IMD), such as a microcontroller associated with a pacemaker.

### BACKGROUND

IMDs for diagnostic or therapeutic purposes do not fully benefit from the accumulated advances in signal processing, data analysis and similar arts. This is because IMDs, just like embedded microprocessors in certain other applications, are subject to extreme constraints on size and/or power consumption. These quantities are correlated and cannot be reduced at the same time, considering that a faster circuit, with a higher degree of parallelization, will have a larger circuit footprint and higher power consumption. Thus, realistic IMDs sometimes fail to offer their programmers certain computational tools that would enable them to achieve clinical goals, to add new functionalities or to work around hardware limitations.

One example of such missing computational tools is the MAc operation, which maps given input vectors ƒ=(ƒ₀, ƒ₁, . . . ƒₙ₋₁), g=(g₀, g₁, . . . gₙ₋₁) to a scalar output

$$f \cdot g = {\sum }_{k = 0}^{n - 1} {f}_{k} {g}_{k} . \qquad ( 1 )$$

This operation, which is also known as product-sum, multiply-add, scalar product, dot product and inner product, occurs in finite-impulse response filters (FIR) and more complex operations such as convolution. More precisely, if the above vectors are regarded as discrete functions ƒ(k)=ƒₖ, g(k)=gₖ, 0≦k≦n−1, then a (discrete) convolution may be defined as the mapping from these functions to the function

$$( f * g ) ( l ) = {\sum }_{k = 0}^{n - 1} f ( k ) {g}_{per} ( l - k ) , 0 \leq l \leq n - 1 , \qquad ( 2 )$$

where gₚₑᵣ(k)=g(k mod n).

The design of multifunctional components is one way to increase the efficiency of microprocessors. US 2008/0229075 A1 discloses a MAc unit as part of a general-purpose central processing unit (CPU). In the interest of cost reduction, the MAc unit utilizes both dedicated hardware and existing CPU hardware to carry out a MAc operation. In particular, two CPU registers are reused and extended by further registers to accommodate wide operands. The MAc uses a sequential multiplier already provided within the CPU and performs the accumulation instruction by means of a dedicated adder and adder registers. The existing CPU bus has been extended in order to serve also the added, dedicated hardware. This known MAc unit offers the programmer a MAc operation similar to that available in dedicated digital signal processors (DSPs) without access to the full hardware set in such processors. A dedicated DSP will obviously perform better than this MAc unit, e.g., by requiring fewer clock cycles to accomplish one MAc operation. Alternative MAc units, that either perform better or are more economical, would therefore be an interesting prospect.

### SUMMARY

It is in view of the above concerns that the present invention has been made. One object of the invention is to provide a MAc unit comprising not only dedicated hardware, as an alternative to the prior art. Another object is to provide microprocessor extensions which form a MAc unit together with hardware already available in a microprocessor, particularly with hardware in a microcontroller in an embedded device, such as an IMD. A further object is to provide a way of operating a microprocessor that lacks a dedicated MAc functionality so that it performs or facilitates a MAc operation at an energy cost acceptable in practical IMD conditions.

Accordingly, the invention provides devices and methods with the features recited in the independent claims. Particular embodiments of the invention are defined by the dependent claims.

Typical IMD designs comprise a large number of interacting components, and both their performance and reliability critically depend on how efficiently these interactions run. A central component like the microprocessor may have been selected at an early stage, typically several years before the release of the product, to allow sufficient time for successive prototypes to be tested and tuned. The designer may have attempted to select a processor with the smallest possible circuit footprint (size), yet with sufficient computing ability (e.g., its maximum number of instructions per second or number of floating-point operations per second) that the processor utilization (e.g., its duty cycle) would be well below 100 percent in its expected normal operating regime. Neither was it desirable to include significant excess capacity, nor was it apparent several years in advance where such excess capacity would have been wisely spent among the various functionalities of the microprocessor. As a consequence of this workflow, new data-processing features that go beyond the original plan—or are introduced in subsequent product releases—can be enabled only to the extent available computational resources in the IMD permit.

The inventor has realized that reusing both the multiplier and accumulator functionalities in an existing microprocessor in a straightforward manner, such as by “for” loops in a high-level programming language, would lead to an overly slow implementation, extending the duty cycle and shortening battery life prohibitively already at a modest data sampling frequency. In terms of circuit footprint, it is not satisfactory either to use dedicated components for both the multiplication and accumulation tasks. The invention balances these considerations by providing, in a first aspect, a MAc unit having a multiplier implemented as a dedicated component with combinatorial logic, while utilizing the accumulation instruction in a sequential arithmetic-logic unit (ALU). The ALU is a shared resource in the sense that it is available for other duties when no MAc operation is being carried out. As the independent claims define in greater detail, the MAc unit includes extensions implemented in dedicated hardware for storage, communication and/or control purposes.

This configuration is advantageous since, firstly, accumulation can be efficiently implemented in sequential logic, wherein one memory can fulfil a double purpose, as a combined operand and result register; the ALU stores the result of an accumulation as one of the two terms for the next accumulation. Secondly, multiplication is a binary operation that lends itself well to a hardware implementation by combinatorial logic circuitry, which makes the product available a very short period after input of the operands and independently of any clock signal. The delay between input and reliable output is sometimes referred to as the FIFO depth (or instruction queue depth) of the combinatorial component. Further, the buffers and/or buses operate independently of the clock signal of the ALU (that is, without a regular or predictable time relationship to this signal, or in a non-synchronized manner, or without time coincidence, or without justification or alignment; alternatively, the buffers and/or buses are not driven by the ALU clock signal; alternatively, the buffers and/or buses initiate their operations at points in time which are variable with respect to the clock signal and which are located arbitrarily with respect to this signal, such as in suitable time intervals of non-zero length). This makes it possible to feed the ALU with new data for the next accumulation cycle in a sequence as soon as it has accomplished the previous one, thereby allowing that the ALU to be run continuously. As already noted, the design of a typical IMD may include a purposeful minimization of the computing ability of the ALU subject to other requirements, and the invention proposes a configuration allowing the limiting resource of the computing system to be run at maximum capacity for the duration of the MAc operation. In contrast, if a clock-synchronous (sequential) bus were used for the data fetching, several clock cycles would be occupied during which the ALU would not complete MAc-related tasks. Yet another advantage lies in the fact that simple, low-width communication buses may be used without detriment to the overall performance; indeed, by virtue of the ALU's independence from the buses (and obviously from the non-sequential combinatorial multiplier as well), the buses may complete the data fetch of an operand in two or more batches, which may still be accommodated within an accumulation instruction in the ALU. For these reasons, the solution proposed by the invention is an advantageous alternative to the device described in the prior art cited previously, and so the invention achieves at least one of its objects.

The microprocessor extensions alone and the MAc processor that they potentially form with an ALU independently fall within the scope of the invention. The microprocessor extensions comprise at least the buffers, the combinatorial multiplier and the first and second communication buses.

In a second aspect, the invention provides a method, preferably for implementation in a finite state machine (FSM), and more preferably for implementation in a FSM within the processing resources in an IMD, for performing a MAc operation. The method comprises:
clearing the combined register in a sequential ALU operating synchronously with a first clock signal;
transferring input data from buffers into operand registers of a combinatorial multiplier using first communication buses, which preferably are direct;
transferring intermediate product data from a result register of the multiplier into an operand register of the ALU using a second communication bus, which preferably is direct, wherein the ALU comprises a further register, which is a combined operand and result register;
repeating the second and third steps until all input data have been processed; and
allowing the ALU to complete the last accumulation operation and extracting the output of the MAc operation from the combined operand and result register of the ALU.
   It is understood that the ALU will be continuously carrying out accumulation instructions for the duration of the MAc operation. By the invention, the first and second communication buses operate independently of the first clock signal.

In a third aspect of the invention, the method may be made available as a computer-program product, or more precisely as computer-readable instructions stored on a data carrier.

In a fourth aspect, the invention relates to use of a sequential ALU in a MAc processor, wherein input data are transferred from buffers to operand registers in a combinatorial multiplier using first communication buses, and intermediate product data from a result register of the multiplier are transferred into the operand register of the ALU using a second communication bus. These communication buses operate independently of the first clock signal. Preferably, the buses are direct, in the sense that they form dedicated transmission lines without passing through a bus controller.

The invention further provides, in a fifth aspect, a MAc unit comprising:
an ALU operating synchronously with a first clock signal and adapted to perform an accumulation instruction; buffers as described above;
a combinatorial multiplier as described above;
first communication buses operating independently of the first clock signal and being adapted to transfer input data from buffers to the multiplier; and
a sequential bus operating synchronously with the first clock signal and being adapted to transfer intermediate product data from the product register of the multiplier and the operand register of the ALU.
   Clearly, this fifth aspect differs from the first aspect in that the task of the asynchronous second communication bus now is fulfilled by a synchronous (sequential) bus, such as a system bus. This structure may be implementable in a broader range of available ALUs, especially if access to the ALU registers is subject to restrictions. In use, the ALU and the synchronous bus perform an uninterrupted sequence of intermediate product data transfers (sequential bus) and accumulation instructions (ALU) cumulating the intermediate product data thus transferred. In a context where both the sequential bus and the sequential ALU are controlled by the same program, generally there is no simultaneity available. Instead the ALU and the sequential bus take turns, so that data transfers and accumulations are alternated. Preferably, the alternation takes place in a one-to-one fashion, so that clock cycles devoted to the accumulation instruction are immediately followed by one or more clock cycle of data transfer over the sequential bus and vice versa. The program controlling the ALU and sequential bus may be an list of assembler instructions executed by a central processing unit (CPU) that includes the ALU.

The microprocessor extensions alone and the MAc processor that they potentially form with an ALU independently fall within the scope of the invention. The microprocessor extensions comprise at least the buffers and the first communication buses.

Analogously with the fifth aspect, a sixth, seventh and eighth aspect of the invention respectively provide a method, computer-program product and an advantageous use of a sequential ALU with an accumulation faculty, a combinatorial multiplier and a sequential bus connecting these.

The variations and further developments which will be outlined below may be applied to any aspect of the present invention.

The first communication buses may extend from the buffers directly to the operand registers of the combinatorial multiplier. This means that the buses offer a dedicated communication line between the buffers and the multiplier, without passing through a bus controller or similar device. In particular, the bus may be direct in the sense that it is independent from a system bus or equivalent device that serves the ALU or a microprocessor that the ALU is part of. The first communication buses may further have a layout allowing data from two buffers to be fed into the operand registers of the multiplier. Also the second communication bus may run from the result register of the combinatorial multiplier directly to the operand register of the ALU.

The microprocessor extensions, and consequently the MAc system as well, may further comprise a FSM adapted to control the first communication buses (and second communication buses, if such are provided) in such manner that the operand register of the ALU stores fresh intermediate product data at initiation of each accumulation instruction in the sequence. More precisely, if only first communication buses are controlled by the FSM, the FSM may be adapted to provided new input data to the multiplier operand registers a suitable period before the clock cycle in which the sequential bus write data from the result register of the multiplier into the operand register of the ALU. Alternatively, if both first and second communication buses are controlled by the FSM, the latter may apply the relevant data at the inputs of the ALU some period before the next accumulation instruction is to be initiated. The FSM may verify that it provides the intermediate product data at the appropriate instants by fetching or receiving a signal that indicates the completion of an accumulation instruction. For instance, the ALU may store this information in status flag registers, which the FSM can poll.

As another option for ensuring correct timing, the FSM may listen to the first clock signal that controls the ALU. Assuming that the ALU effects a new accumulation instruction at every N^{th} positive or, as the case may be, negative clock signal edge, the FSM may verify that the intermediate product data were indeed provided to the ALU at the correct interval or point in time. The verifying may take place after each accumulation instruction or intermittently at regular or irregular time intervals. It is noted that the clock signal alone contains less information than the status signal, since the FSM may then need to count all clock cycles continuously to keep track of the beginnings of new accumulation instructions.

Additionally or alternatively, the FSM may retrieve an indication of whether intermediate product data are available in the result register of the combinatorial multiplier. This indication may consist in a change of the value of a status register or an output signal of the multiplier. In the absence of such an indication, the FSM may predict the instant at which the multiplication will have been completed. More precisely, this instant is likely to occur a period, which corresponds to the FIFO depth of the multiplier, after the latest change to the operands of the multiplier. When the indication has been received, the FSM may activate the second communication bus, so that intermediate product data are transferred to the ALU.

The FSM may be operable in a low-power mode. Hence, in addition to its normal mode, in which it controls the communication buses connecting the multiplier with buffers and/or ALU, it may enter a low-power mode until a subsequent MAc operation is to be executed. Such low-power mode may include suspending the output signals (see below) or logical components of the FSM or in interrupting any polling for data from the multiplier and/or the ALU.

There are several ways in which the FSM may control the communication buses. Advantageously, some or all of the buses are controlled by means of strobes. As used herein, a strobe is a selection signal that is active when data are correct on a bus. The strobe may also indicate the start or end of the data. It may be encoded with a different potential or time-length or may use a dedicated wire in a parallel bus. In general, a strobe is used to synchronize the data in an electric bus when the bus components lack a common clock. In the invention, one strobe may be used to facilitate the FSM's control of a first communication bus or both first communication buses; when the signal is active, the relevant bus(es) establish(es) a link (pass-through) between its endpoints, so that the operand register of the multiplier coincide with the data word at a current memory position in the corresponding buffer. Further, the FSM may use a different strobe to control the second communication bus, which in the active state of the strobe equates the data words at its endpoints.

If a low-width communication bus is employed, the FSM may be adapted to cause the bus to transfer data to an operand register by portions smaller than a number in the input data, that is, in two or more batches for each accumulation instruction.

The FSM may be a Moore machine (input-independent) or Mealy machine (input-dependent). Preferably, the FSM is a Mealy machine. A Mealy machine is typically capable to generate a pulse in response to a state transition, which may provide for a more efficient implementation.

As an alternative, while being independent from the first clock signal, which controls the operations of the ALU, the buses and/or buffers may be controlled by a different, second clock signal. The second clock signal may be generated by the FSM or some other component. There is no obvious advantage in synchronizing the first and second clock signals. Rather, a non-zero phase difference between these signals is advantageous and may allow use of a lower, less energyconsuming bus frequency, as will be explained in more detail below. In typical implementations, the second clock frequency is equal to the first frequency or higher.

It is to be noted that the FSM does not necessarily control all the communication buses. A possible alternative solution is the following: The FSM controls the first communication buses, whereas the second communication buses are activated by a separate controller adapted to activate the second communication bus in response to a change into an active state of a signal indicating that the multiplier output (intermediate product data) has stabilized and is available.

The buffers may include buffer logic for facilitating the addressing of the storage locations in the buffers. In each buffer, the buffer logic may include a read pointer register, which stores an effective address to which the next buffer read operation will refer and which will therefore be updated at every buffer read operation. The logic may further include a modifier register, which is responsible for said updates by storing an increment by which the read pointer register is modifled between consecutive read operations. Preferably, the increment is signed and may thus express either a forward or backward shift of the pointer in the address space. The logic may as well include a data length register, by which a periodicity may be imposed on the input data. The joint update action defined by a pointer register PTR, a modifier PMOD and a data length register PLEN, may be expressed as

PTR:=(PTR+PMOD)mod PLEN. (3)

A buffer read operation triggering said updating operation may be evidenced by an active period of a strobe signal controlling the first communication bus connecting the buffer to the multiplier. An active bus strobe signal may be easily detected by the buffer logic.

In a further development, the buffer logic may include a write pointer register as well and associated modifier and data length registers, analogously to the description already given. As a simple alternative, all buffer write operations may be directed to the same memory location, while shifting the already stored data away from the input location along the buffer.

The ALU may be a general-purpose component. Preferably it offers the set of instructions generally encountered in a Z80 architecture. This not only enables MAc-related operations but also makes the ALU well suited for the computational tasks other than MAc. Hence, an IMD equipped with a Z80-architecture ALU and the extensions proposed by the invention will be able to fulfil the normal computational duties expected from such a device while offering an efficient implementation of the MAc functionality. Neither does this require modifications to existing software modules, nor does it necessitate the provision of further hardware components. As used herein, Z80 architecture refers to the microprocessor Zilog Z80, which was originally conceived and sold by Zilog, Inc., San Jose Calif., United States, and its successors. The term Z80 architecture is also meant to cover devices which lack a relationship to Zilog Z80 or Zilog, Inc. but which are nevertheless suitable for replacing Zilog Z80 by offering similar capabilities, having a similar instruction set, or by being equipped with similar I/O interfaces or internal hardware and software. In particular, the term is meant to cover any microprocessor that offers a superset of the Zilog Z80 instruction set, since this microprocessor will be able to replace Zilog Z80. Alternatively, the ALU may be one of the following architectures: 6502, 6800, 68000, 8051, x86 and RISC.

Also with the aim of providing a general-purpose processing device, there may be a further connection between the ALU and the combinatorial multiplier. The connection is preferably provided in the form of a communication bus operating synchronously with the first clock signal. This communication bus may be (a portion of) a system bus. This allows the ALU to use the multiplier for speedy multiplication of large numbers even outside the context of MAc operations.

Further to fulfil the same aim, the ALU may be adapted to offer a minimal set of instructions. Such minimal set preferably includes the following instructions: and, compare, multiply, or, subtract, xor.

It is economical to activate only those components of the processor that are actually required to perform an operation or instruction. To this end, one or more of the buffers, multiplier, communication buses and, if such is provided, the finite state machine may be suppressed unless a MAc operation is being carried out. The suppression may simply consist in interrupting the electric power supply to these devices, possibly with the exception for power sufficient to avoid loss of stored data.

A processor formed by an ALU and the microprocessor extensions in accordance with the above teachings may advantageously form part of an implantable medical device. In particular, the processor thus formed may be used in an implantable pacemaker.

In one embodiment, there are provided microprocessor extensions for performing a MAc operation in cooperation with an ALU, which operates synchronously with a first clock signal, and a combinatorial multiplier. The ALU and the combinatorial multiplier are connected by a communication bus allowing intermediate product data to be transferred from a result register of the multiplier to an operand register of the ALU. The ALU is operable to perform an accumulation operation in respect of the operand register and a combined operand and result register. The extensions include:
buffers for storing sets of input data on which said MAc operation is to be performed; and
first communication buses for transferring input data from the buffers into operand registers of the combinatorial multiplier, wherein the first communication buses operate independently of the first clock signal.
   The communication bus connecting the ALU and the multiplier either operates synchronously with the first clock signal or operates independently of the first clock signal. In either case, the first communication buses are adapted to provide the input data in such manner that the ALU (and the second bus, if this operates synchronously with the first clock signal) is allowed to operate at maximum speed, so that for the duration of the MAc operation no clock cycle is wasted. A finite-state machine may be responsible for activating the communication buses in appropriate time intervals.

In one embodiment, the invention provides a method for performing a MAc operation by means of a sequential arithmetic-logic unit, which operates synchronously with a first clock signal and is adapted to perform an accumulation instruction in respect of an operand register and a combined operand and result register. The method includes the steps of:

i) clearing the combined operand and result register;

ii) transferring input data from buffers into operand registers of a combinatorial multiplier using first communication buses;

iii) transferring intermediate product data from a result register of the combinatorial multiplier into the operand register of the ALU using a second communication bus;

iv) repeating steps ii) and iii) until all input data have been processed; and

v) allowing the arithmetic-logic unit to complete the last accumulation instruction and extracting output data from the combined operand and result register.

In this embodiment, step ii) includes using communication buses operating independently of the first clock signal. Step iii) may be performed by means of a communication bus operating synchronously with the first clock signal or a bus operating independently of this clock signal. Similarly to the previous embodiment, the ALU and possible connected clock-synchronous devices are allowed to operate at full speed for the duration of the MAc operation. A finite-state machine may control the first communication buses, and, possibly, the second communication buses as well.

### BRIEF DESCRIPTION OF THE DRAWINGS

These and other aspects of the invention will be apparent from and further elucidated by the following description of particular embodiments. Reference is made to the accompanying drawings, on which:

FIG. 1 is a generalized block diagram of MAc processor which is formed by an ALU and extensions to this, in accordance with a first embodiment of the present invention;

FIG. 2 is a detailed view of a data buffer for deployment in the embodiment shown in FIG. 1 or a similar device;

FIG. 3 is a generalized block diagram of a MAc processor, which may be regarded as a further development of the processor of FIG. 1;

FIG. 4 is a more complete block diagram showing either of the MAc processors in FIG. 1 or 3, in which there is indicated a data connection between the ALU and the combinatorial multiplier, wherein said connection enables a more versatile use of the processor or may even replace the second communication bus;

FIG. 5 is a flowchart of a method for performing a MAc operation, in accordance with an embodiment of the invention;

FIG. 6 is time plot of control signals and memory content in a processor similar to the one shown in FIG. 1;

FIG. 7 comprises time plots of control signals in processors wherein the microprocessor operate synchronously with a second clock signal; and

FIG. 8 is a generalized block diagram of a MAc processor, in which the multiplier and the ALU are directly connected by a clock-synchronous communication bus.

### DETAILED DESCRIPTION OF EMBODIMENTS

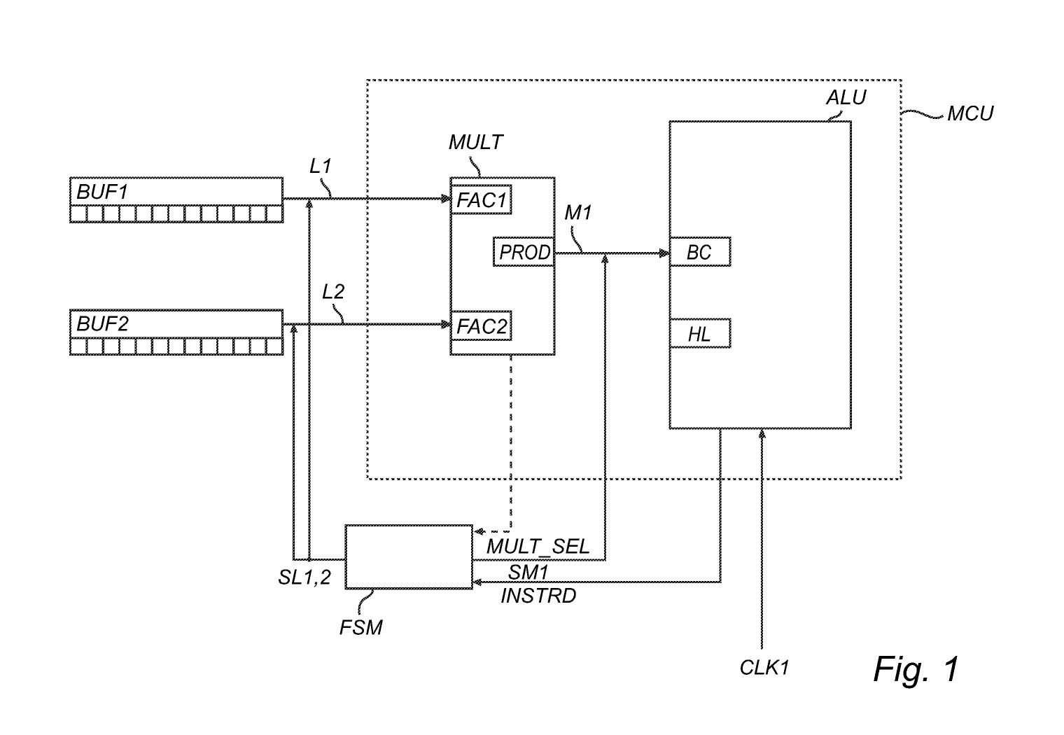

FIG. 1 shows a microcontroller unit MCU comprising an arithmetic-logic unit ALU and a combinatorial multiplier MULT. The ALU may be one of the architectures mentioned above, in particular the Z80 architecture, and so possesses basic functionalities, including a set of simple arithmetic and I/O instructions. It comprises two multi-bit registers BC, HL for storing the operands in an accumulation instruction, wherein the values of the operand registers BC, HL are added and the result is written to one of the registers HL, which is, therefore, a combined operand and result register in respect of the accumulation instruction. The reference signs, e.g., “BC”, used in the figure are not to be construed as an incentive to use a register carrying this particular label in an actual, physical processor. The register may also be formed of a combination of several sub-registers.

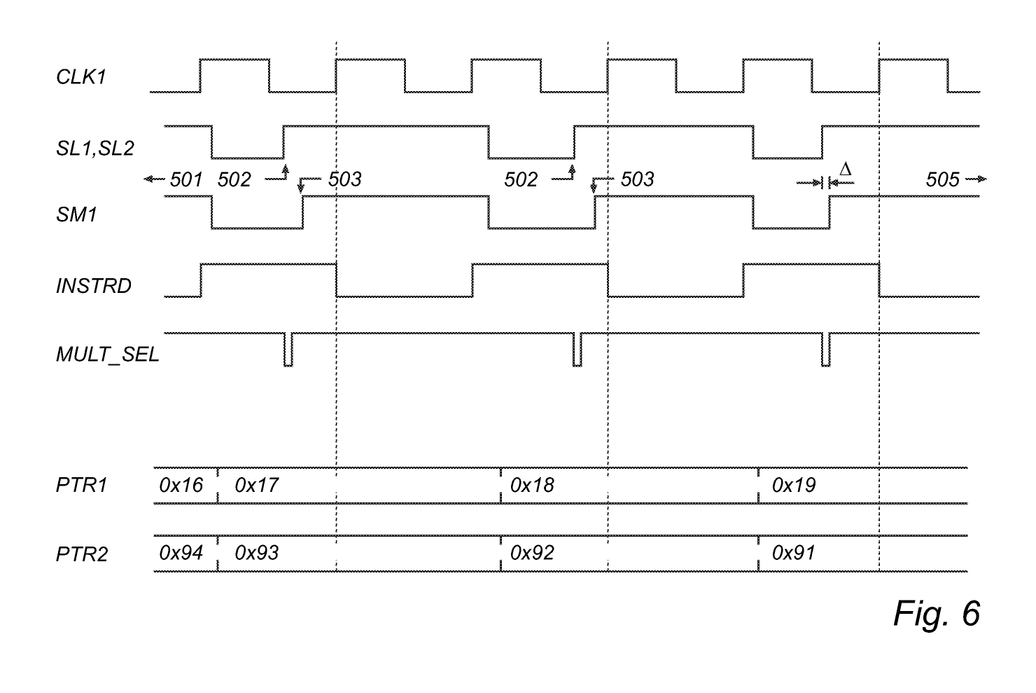

The ALU is a sequential component, which is a precondition for the twofold use of the operand and result register HL insofar as the significance of the stored data can be separated in time by belonging to clock cycles. The ALU is supplied with a clock signal CLK1, which may have the general appearance shown in FIG. 6. The clock signal CLK1 may function as a system clock of the microcontroller unit MCU. For the purposes of this description, it will be assumed that a clock cycle begins at a positive edge of the clock signal unless otherwise stated.

The combinatorial multiplier MULT has two operand inputs FAC1, FAC2 and one result output PROD. Since the multiplier is not clock-operated, the result of the multiplication appears at the output PROD instantly in an idealized model. A real multiplier may however be composed of cascaded logic components operating at finite speed, and so the output signal from the multiplier MULT as a whole may not stabilize until after a finite period of time. The period after which the output is reliable, the FIFO depth of the component, may be predetermined. An indication to a similar effect may be had from a select signal MULT_SEL which changes into a “ready” state when sufficient time has passed from the latest change of the input signals to the multiplier MULT.

The microcontroller unit MCU may comprise several other sections than the multiplier MULT and the ALU, including data lines (not shown) for linking these components to one another, in particular one or more system buses.

The microprocessor extensions that the invention proposes additionally include buffers BUF1 and BUF2 for storing the vectors that form the inputs to the MAc operation. As will be described in more detail below, the buffers BUF1, BUF2 comprises a plurality of memory spaces for storing vector entries (components). Hence, preferably, the size (width) of individual memory spaces is compatible with those of the inputs to the multiplier MULT. The buffers BUF1, BUF2 are adapted to provide input data (entries of the input vectors) to the operand inputs FAC1, FAC2 of the multiplier MULT via two first communication buses L1, L2 operating independently of the first clock signal CLK1. A second communication bus M1 is operable to connect the result register PROD of the multiplier to the (pure) operand register BC of the ALU. Its purpose is to forward intermediate product data corresponding to each term of the sum in equation (1) above. The second communication bus M1 forms part of the extensions provided by the invention and not of the microcontroller unit MCU itself; if the ALU and multiplier MULT are already connected through a system bus or the like, the second communication bus M1 is intended to provide a dedicated, direct data connection that is independent of the first clock signal CLK1.

The embodiment shown in FIG. 1 further comprises a finite state machine FSM, which may be a Mealy machine, or preferably a Moore machine, that is adapted to control the communication buses L1, L2, M1. The FSM controls the first communication buses L1, L2 by means of first strobes SL1, SL2, which connect the FSM to each communication bus, and similarly controls the second bus M1 by a second strobe M1. In embodiments wherein the values of the first strobes SL1, SL2 coincide at all times, or may do so without inconvenience, the two first strobes may be replaced by one single strobe extending from the FSM to both first communication buses L1, L2. Examples of signals occurring at these strobes and generated by the FSM are illustrated in FIG. 6. In this embodiment, the FSM generates the strobes on the basis of a status signal INSTRD, which may be encoded with a status flag in the ALU that is susceptible of polling, and which indicates that an accumulation instruction has been completed in the previous cycle. As FIG. 6 illustrates, if the accumulation instruction takes two cycles to complete, the status signal will be low in the first clock cycle and high in the second cycle, thereby indicating that the relevant result register now contains the result of the operation. Using this information, the FSM is adapted to react to a change into the positive state of the status signal INSTRD by activating the first communication buses L1, L2 and then also the second communication bus M1, so that the next portion of intermediate product data is applied to the ALU input before the status signal INSTRD changes into its negative state. The activation of the first communication buses L1, L2 is achieved by setting the first strobes SL1, SL2 to their positive state, which is indicated as step 502. The activation of the second communication bus M1 corresponds to changing the second strobe SM1 to its positive state, in step 503. This way, said intermediate product data are written to the operand register BC of the ALU at the beginning of the next clock cycle, which is indicated in FIG. 6 by a dashed vertical line. It is emphasized that the respective activations of the communication buses L1, L2, M1 need not happen at a special instant in time, but may vary independently of one another as long as they are contained within a single clock cycle with a positive status signal INSTRD value. In the example shown in FIG. 6, the second communication bus M1 is activated a short while after the first communication buses L1, L2, which follows by the fact that the positive edges of the first strobes SL1, SL2 are not closer to the positive edges of the second strobe SM1 than a predetermined period denoted A, which corresponds to the FIFO depth of the combinatorial multiplier MULT. This way of operating the buses has the advantage that unreliable or obsolete intermediate product data are never made available to the ALU. However, if it can be tolerated that the ALU is fed with such unreliable data in between the instants at which data are actually written to the ALU operand register BC this may be the case if the ALU is configured to be unaffected by values provided to it between the write instants then the first and second communication buses may be activated simultaneously or even in the reverse order. In one embodiment, the FSM may be adapted to keep the second communication bus M1 active for the whole duration of a MAc operation, whereby the value of the result register PROD of the multiplier MULT is constantly applied to the input to the operand register BC of the ALU. In these variations, it is suitable to take proper account of the FIFO depth of the combinatorial multiplier MULT, that is, the input values fed to the multiplier are preferably not allowed to change in a final segment of length Δ prior to the instant at which data are written from the multiplier MULT into the operand register BC of the ALU.

In another embodiment, the FSM may, as an alternative or a supplement, use a select signal MULT_SEL from the multiplier MULT in order to determine suitable time intervals in which to activate the communication buses L1, L2, M1. Such a signal MULT_SEL, which is not necessarily available, has been indicated by a dashed connection line in FIG. 1. If the select signal MULT_SEL changes into its “ready” state after new input data have been supplied to the multiplier MULT, then the FSM may consider the data supplied at the output of the multiplier MULT as reliable and thus susceptible of being forwarded to the ALU.

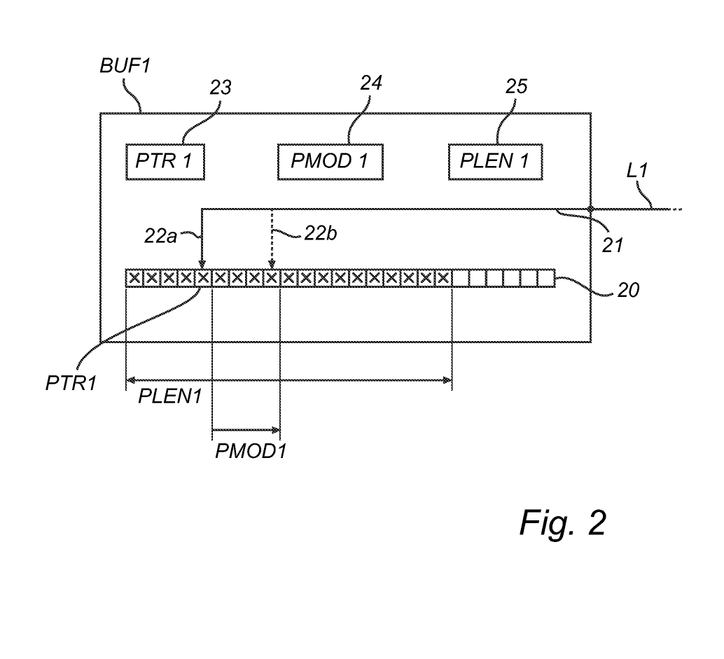

With reference now to FIG. 2, an arrangement for addressing memory spaces 20 within the buffers BUF1, BUF2 will now be described. In a typical use situation, each of the buffers contains an operand (input vector) to the MAc operation, from which vector individual numbers are extracted, multiplied pairwise and added. As suggested by equation (2), this may amount to data being read from memory locations that are successive in one direction in one buffer and are successive in the reverse direction in the other buffer. More generally, the memory locations may be consecutive or separated by predetermined intervals. The buffer memories are preferably memory-mapped so that arbitrary spaces within them can be addressed and accessed. However, in a processor adapted for a given application, it may be expedient to equip the buffers BUF1, BUF2 with logic that is responsible for the addressing. More precisely, each buffer may include a read pointer register 23 storing the address PTR1 of a read pointer 22 determining from where data are extracted, via the internal connection line 21 leading up to the connection point of the communication bus L1, the next time the communication bus L1 is active. The read pointer is updated between consecutive activation periods of the communication bus, and to this end the buffer logic further comprises a modifier register 24 for storing a signed increment PMOD1, such as ±1, ±2, ±3, . . . , and a data length register 25 for storing a number PLEN1 which indicates to the logic when one of the ends of the set of currently used memory spaces has been reached, wherein the pointer should initiate a new round starting from the opposite end. In one embodiment, the value PTR1 of the read pointer register 23 is updated by equation (3) above. Equation (3) may be evaluated by an address generator (not shown) in the buffer BUF1. FIG. 1 shows an exemplary case, wherein the increment PMOD1 is +4 and the data length is 19. Consequently, the read pointer 22 will jump back to a position at the left end of the memory spaces 20 after every fourth or fifth increment. If for some reason it is desirable to begin the sequence of memory spaces at some offset from the zeroth space, then the skilled person will readily be able to modify this arrangement accordingly.

As already noted, the updating may be triggered by a deactivation of the first communication bus L1 connected to the buffer BUF1, as evidenced by a change between active and inactive values of a corresponding strobe SL1. Alternatively, it may be triggered by the inverse of the second strobe SM1. FIG. 6 shows values of the read pointers PTR1, PTR2 of the first and second buffers BUF1, BUF2. It can be seen that the first read pointer PTR1 is increased by one unit when the strobes change into their low value. Meanwhile, the second read pointer PTR2 is decreased by one unit. Other triggers may be conceived and applied within the scope of the present invention. As one example, the FSM may be adapted to utilize a dedicated trigger signal in order to cause the buffer logic to advance to the next stored value in the buffer. The second buffer BUF2 may have a similar structure as that shown in FIG. 2. Similar logic for addressing the memory during write operations may be included in one or both buffers, especially in a buffer intended for measured data since this will be subject to frequent write operations. The updating of a write pointer register (analogous to the read pointer register) may be triggered by the action of addressing a memory address within the concerned buffer, as evidenced, e.g., by the value of an address bus (not shown) in the microprocessor, to which by the buffer and the measuring means are connected.

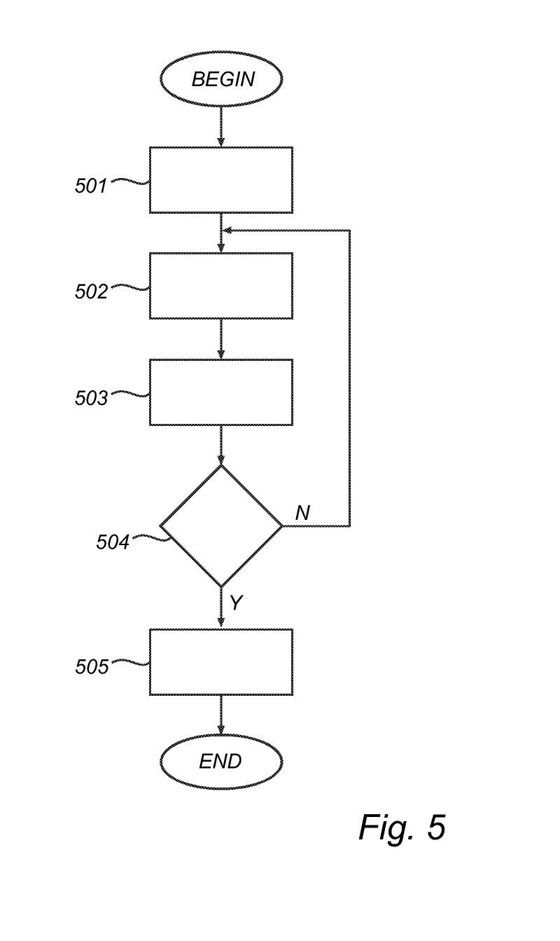

The functioning of the extensions described above, as well as their cooperation with an ALU performing a continuous sequence of accumulation instructions, will now be summarized with reference to the flowchart in FIG. 5. A particular use envisioned for the present invention, which may serve as an example for in this description, is for subjecting measured data points to a finite impulse response (FIR) filter. The data points may have been captured by a transducer within a sensor or measuring device communicatively connected to the processor, possibly via an analog-to-digital converter and other devices that the skilled person will select and deploy without difficulty. Such data points may be stored in one buffer BUF1, which is then updated with new data (e.g., by shifting out the oldest data) in connection with measurements. The filter coefficients may be stored in the other buffer BUF1, the content of which is therefore relatively more constant and has a length corresponding to the tap number of the filter. An evaluation of the currently stored data points with respect to the filter coefficients is described by equation (1), where vectors ƒ,g correspond to filter coefficients and data points, respectively.

In a first step 501, the combined operand and result register HL in the ALU is cleared of its previous values, e.g., by writing a zero.

In a second step 502, the FSM transfers the first pair ƒ₁,g₁ of input data points from the respective buffers BUF1, BUF2 to the inputs of the multiplier MULT. To this end, the FSM may activate the first communication buses L1, L2, as discussed above. After a small or negligible delay corresponding to the FIFO depth of the multiplier, a reliable result of the multiplication is available at the output PROD, namely the intermediate product ƒ₁g₁.

In a third step 503 then, the FSM effects the transfer of the intermediate product data to the operand register BC of the ALU via the second communication bus M1. The third step is to be completed a short while prior to the next instant at which the ALU initiates the next accumulation instruction in the sequence, this instant being indicated by a vertical dashed line in FIG. 6. Because this is the first accumulation instruction after the clearing of the combined register HL, the ALU will then add the intermediate product ƒ₁g₁ to zero and store the result in the combined register HL. It is noted that the second and third steps 502, 503 of transferring data to and from the multiplier MULT are necessarily carried out in the order set out here. However, while the relevant communication buses have to be active when the transfer is to take place, it may not always be necessary to deactivate the buses otherwise. It is also possible to activate the communication buses over extended intervals having start points and end points with an order that is different from the order of the transferring steps 502, 503. In particular, the start points and/or end points of the intervals may coincide. As noted above, the second communication bus may even be maintained active throughout the MAc operation if it can be tolerated that incorrect data are fed to the ALU in between the write instants.

In a fourth step 504, it is assessed whether or not all data points have been processed. In terms of equation (2), it is checked whether the summation index has reached its final value k=n−1. If not, the second and third steps 502, 503 are repeated. On the first repetition, the ALU will be presented with the second intermediate product ƒ₂g₂, which will be added to the already stored first intermediate product, from which it will result that the combined register HL will contain ƒ₁g₁+ƒ₂g₂ after completion of the second accumulation instruction.

In a fifth step 505, it will have been established in the last repetition of the fourth step 504 that no more intermediate products need to be fed to the ALU. Since the ALU will perform the accumulation instruction in finite time, such as two clock cycles, this time must elapse before the result of the MAc operation is extracted from the combined register HL. This is the endpoint of the method.

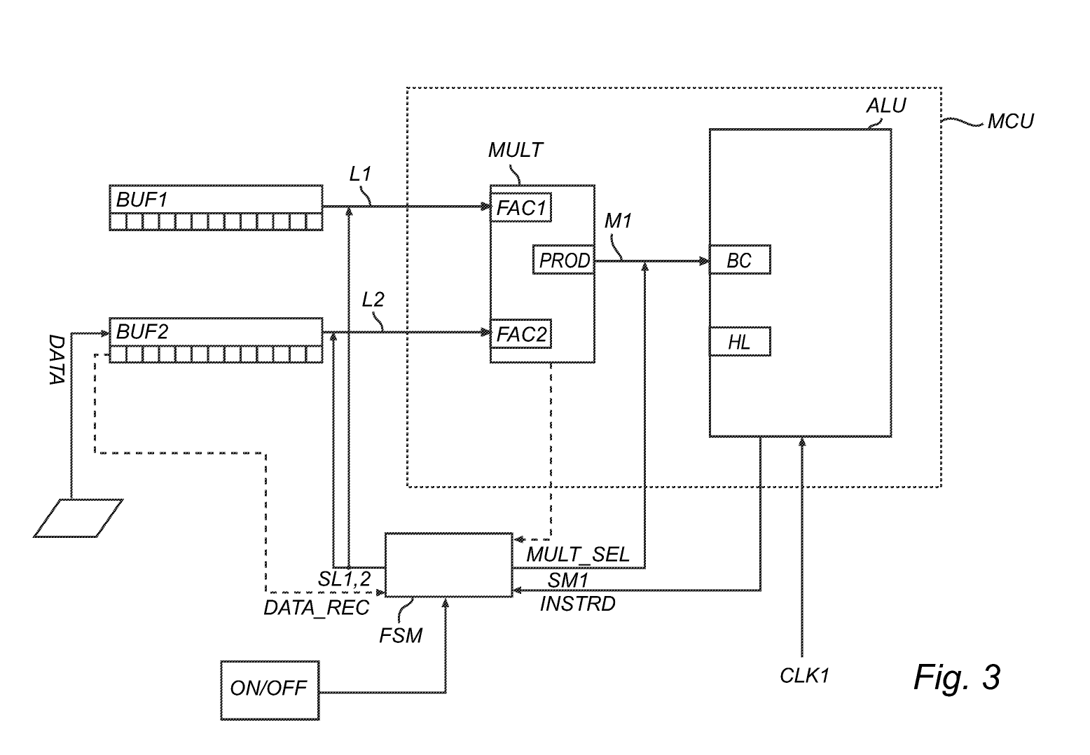

FIG. 3 shows an ALU and extensions which cooperate with the ALU and represent an alternative embodiment of the present invention. FIG. 3 clarifies that it is the second buffer BUF2 that receives external measurement data, while the first buffer BUF1 contains previously stored data, such as filter coefficients. In addition to the circuitry shown in FIG. 1 (wherein any optional entities in that embodiment remain optional here), this embodiment includes a controller ON/OFF for activating or deactivating the FSM. The controller may help optimize the use of energy, which is particularly important in battery-powered devices. The controller may be configured to so that it automatically turns the FSM off after completion of a MAc operation. It may also be timer controlled, so that the FSM is turned off after a predetermined period.

Another additional, optional feature shown in FIG. 3 is a connection DATA_REC from the second buffer BUF2 and the FSM. Such connection may be used to inform the FSM that a new data item has been written to the second buffer BUF2. This may facilitate the programming of the FSM in practical application. For instance, in a situation where the device shown in FIG. 3 is used to process successive data values arriving at time instants separated by more time than the duration of one MAc operation, the second buffer BUF2 may notify the FSM directly via the connection DATA_REC when there are updated data due to be processed.

A particular embodiment includes the connection DATA_REC from the second buffer BUF2 to the FSM, the select signal MULT_SEL from the multiplier MULT to the FSM and the status signal INSTRD from the ALU to the FSM. The devices may then be configured as follows:
The FSM activates the first communication buses L1, L2 in response to either a notification from the buffer BUF2 of new data or in response to a positive status signal INSTRD from the ALU.
The FSM activates the second communication bus M1 in response to a change into the “ready” state of the select signal MULT_SEL from the multiplier MULT.
The ALU carries out only a number PLEN2 (or PLEN1) of accumulation instructions corresponding to the number of stored data values (or filter taps). Hence, when the end the MAc operation has been reached, the FSM stops automatically.

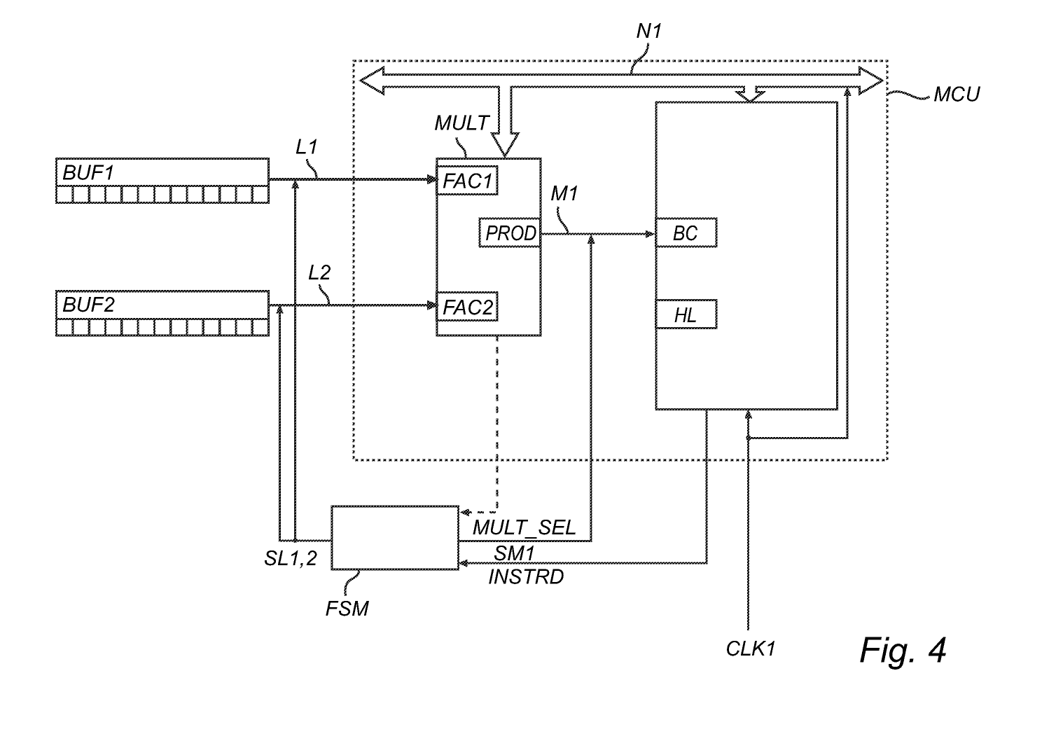

FIG. 4 shows a MAc processor, wherein the ALU and multiplier MULT have been drawn together with the sequential system bus N1 of the microcontroller unit MCU. The system bus N1 operates synchronously with the first clock signal CLK1 and is thus synchronized with the ALU as well. This device represents a versatile processor which, in addition to the MAc operations described above, carries out simple standard instructions, such as and, compare, decrement, increment, load, multiply, or, subtract, shift, xor etc. The system bus N1 also enables the processor to multiply wide operands efficiently by using the combinatorial multiplier MULT. With a view to energy efficiency, the processor is preferably adapted to suppress (or power off) the not-needed components when simple standard instructions are carried out. As such, the communication buses L1, L2, M1 and FSM may be suppressed during a wide-operand multiplication. For the simple standard instructions exemplified above, the multiplier MULT may be suppressed as well.

Still with reference to FIG. 4, a further embodiment of the invention includes use of the system bus N1 for forwarding data from the multiplier MULT to the operand register BC of the ALU. This approach may be advisable in a situation where access to the ALU registers is limited, e.g., due to logical restrictions imposed by the manufacturer. In terms of Z80 pseudo-instructions, this may amount to substituting

LD BC,[mul_prod_reg_lo]

ADD HL,BC

for every occurrence of

ADD HL,BC

that would normally be given to a central processing unit controlling the ALU. The above LD instruction loads the content from the PROD register in the combinatorial multiplier MULT via the system bus N1 into the BC register of the ALU. As such, this embodiment provides a MAc processor which, in addition to a sequential ALU that operates synchronously with a first clock signal CLK1, comprises:
buffers BUF1, BUF2 as described above;
a combinatorial multiplier MULT as described above;
first communication buses L1, L2 operating independently of the first clock signal and being adapted to transfer input data from buffers to the multiplier; and
a system bus N1 operating synchronously with the first clock signal CLK1 and being adapted to transfer intermediate product data from the product register PROD of the multiplier MULT and the operand register BC of the ALU
   It is noted that the second communication bus M1 is never active in this embodiment and may be omitted. Likewise, the FSM need not generate the second strobe SM1 for controlling the second communication bus M1. In comparison with the previously disclosed embodiments, the present one may perform less well under similar conditions considering that the intermediate product data are forwarded by means of the synchronous system bus N1 instead of a clockindependent bus. Clearly, at least one clock cycle between consecutive accumulation instructions is devoted to fetching the intermediate product data. Hence, if each accumulation instruction requires two cycles, the total MAc instruction may take 50 percent more time to accomplish.

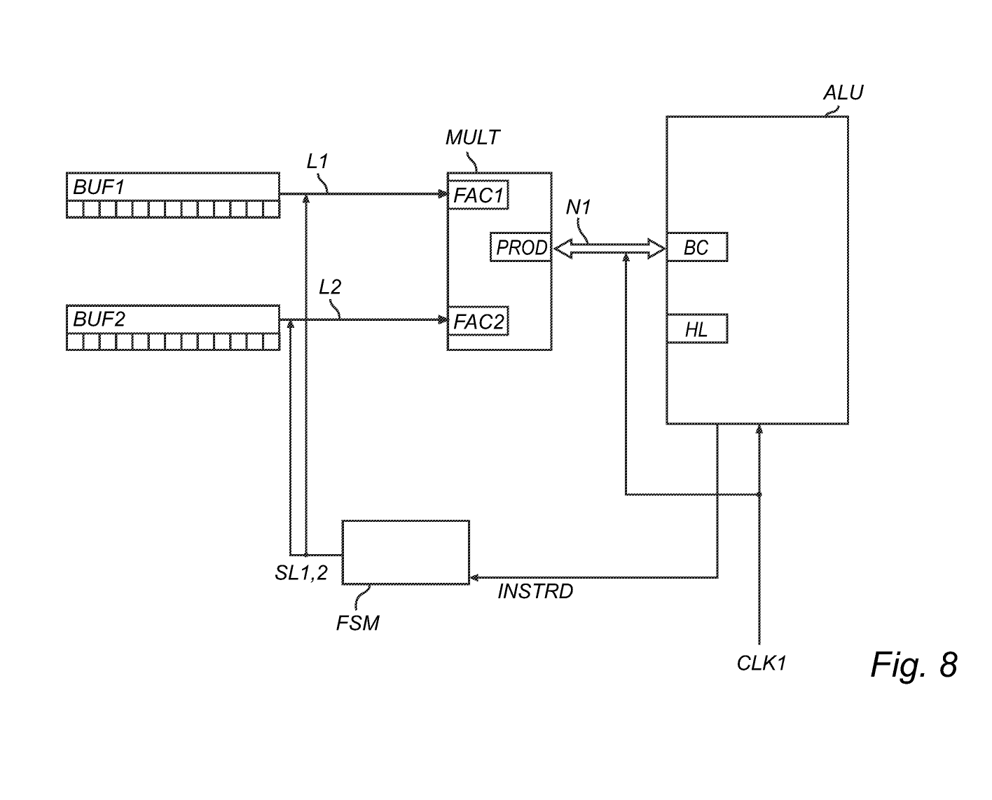

As FIG. 8 shows, the clock-synchronous communication bus N1 responsible for forwarding intermediate product data need not be a system bus but may also be configured as a dedicated bus extending directly between the multiplier MULT and the ALU. Similarly to the system bus in the preceding embodiment, this dedicated communication bus N1 may be controlled by a central processing unit adapted to control the ALU as well. It is noted that the FSM in the MAc processor of FIG. 8 only requires the status signal INSTRD as input in order to generate control signals SL1, SL2 intended for the first communication buses L1, L2. From the value of this signal, the FSM is able to derive a suitable time interval in which to feed new input data to the operand registers FAC1, FAC2 of the multiplier MULT using the first communication buses L1, L2.

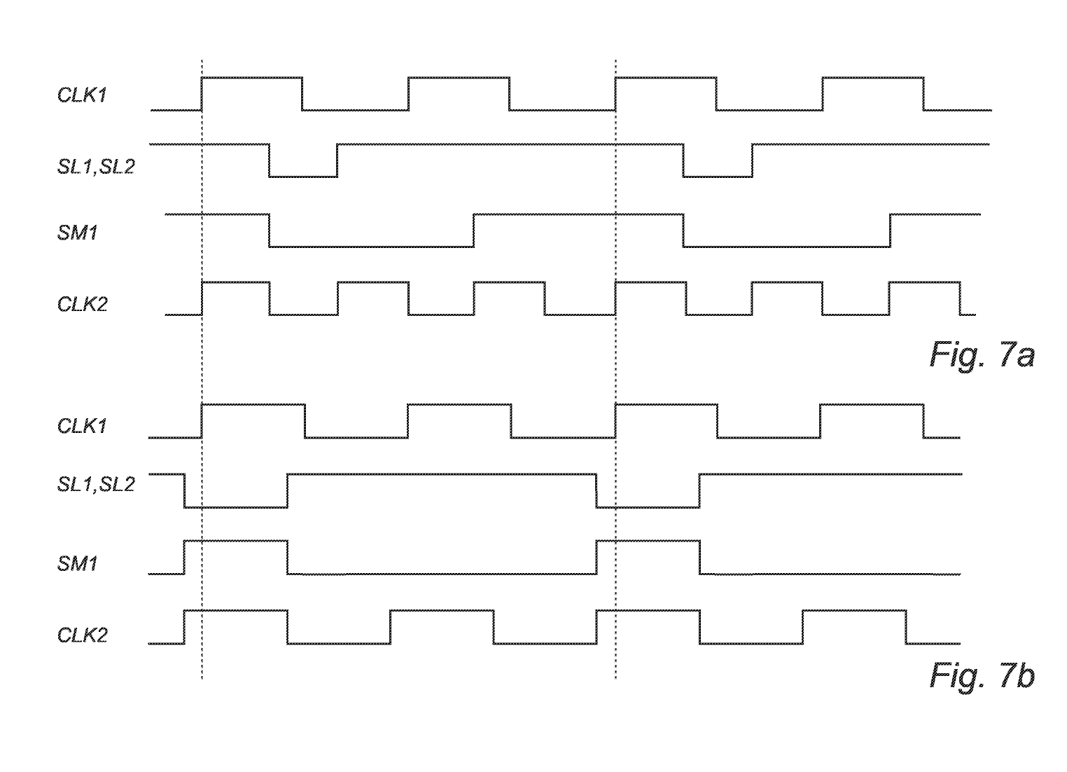

FIG. 7a is a time plot of five binary control signals CLK1, SL1, SL2 (wherein SL2=SL1), SM1 as described above and a second clock signal CLK2, which is provided to the microprocessor extensions. The vertical dashed lines indicate instants at which the ALU initiates an accumulation instruction, which is when data provided to the ALU by means of the second communication bus M1 is written into its operand register BC. In this example, the frequency of the sec- and clock signal CLK2 is 3/2 times the frequency of the first clock signal CLK1, and certain pairs of positive edges coincide in time. In this embodiment, the control signals SL1, SL2, SM1 to the communication buses L1, L2, M1 are strobes in the sense that they activate the concerned communication bus so that data words at its endpoints are equated. The first communication buses L1, L2 are activated in the 2^{nd} cycle, prior to the activation of the second communication bus M1, which happens in the 3^{rd} cycle. Hence, the output (intermediate product data) of the multiplier MULT will be allowed to stabilize during the 2^{nd} cycle before it is forwarded to the ALU, thereby avoiding the risk of incorrect data being introduced into the MAc computation. Without any obvious inconvenience, the second clock signal CLK2 may operate at a higher frequency than 3/2 of the first clock frequency, as disclosed in FIG. 7a; the use of such higher frequencies may however increase the energy consumption of the components.

FIG. 7b is a time plot of the same control signals as in FIG. 7a. The two clock signals CLK1, CLK2 have equal frequencies but are separated by a non-zero phase difference. In this embodiment, the microprocessor extensions are implemented in sequential logic, which also falls within the scope of the present invention. References to the strobes SL1, SL2, SM1 are to be interpreted accordingly, in the context of sequential buses. The components of the microprocessor extensions are configured as follows:
A falling signal (e.g., a status signal INSTRD) triggers, with a one-cycle delay, a falling first strobe signal SM1 to allow ALU prefetch.
The second communication bus M1 is triggered by a negative edge on the second strobe SM1.
The first strobe SL1 is the logical inverse of the second strobe SM1.
The transfers from the buffers BUF1, BUF2 are triggered by a negative edge on the first strobe SL1. Thus, the first communication buses L1, L2 will write their input data a half second-clock CLK2 cycle after the transfer over the second communication bus M1.
   Preferably, the unit responsible for generating the second clock signal CLK2 (e.g., the FSM) verifies at appropriate intervals that the phase difference with respect to the first clock signal CLK1 stays within suitable limits.

A use currently envisioned for the processor formed by an ALU and the extensions disclosed herein is in an IMD and particularly a pacemaker device. The data processing may include subjecting cardiac data collected by sensors connected to the IMD to appropriate digital filters, so as to extract data relevant to diagnosis or therapy. The cardiac data may be obtained by sampling physiological electric signals.

Further embodiments of the present invention will become apparent to a person skilled in the art after studying the description above. Even though the present description and drawings disclose embodiments and examples, the invention is not restricted to these specific examples. Numerous modifications and variations can be made without departing from the scope of the present invention, which is defined by the accompanying claims. Technical features may be combined to advantage even though they are recited in different claims or in connection with different embodiments.

The systems and methods disclosed hereinabove may be implemented as software, firmware, hardware or a combination thereof. In a hardware implementation, the division of tasks between functional units referred to in the above description does not necessarily correspond to the division into physical units; to the contrary, one physical component may have multiple functionalities, and one task may be carried out by several physical components in cooperation. Certain components or all components may be implemented as software executed by a digital signal processor or microprocessor, or be implemented as hardware or as an application-specific integrated circuit. Such software may be distributed on computer readable media (or data carriers), which may comprise computer storage media (or non-transitory media) and communication media (or transitory media). As is well known to a person skilled in the art, computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media typically embodies computer readable instructions, data structures, program modules or other data in a modulated data signal such as a carrier wave or other transport mechanism and includes any information delivery media.

1. Microprocessor extensions for performing a multiply-and-accumulate, MAc, operation, by cooperating with:
a sequential arithmetic-logic unit, which operates synchronously with a first clock signal and is adapted to perform an accumulation instruction in respect of an operand register and a combined operand and result register;
a combinatorial multiplier comprising two operand registers and a result register; and
a sequential bus operating synchronously with the first clock signal and connecting the result register of the combinatorial multiplier to the operand register of the arithmetic-logic unit,
wherein the arithmetic-logic unit and the sequential bus are configured to perform a continuous sequence of transfers of intermediate product data from the result register of the multiplier to the operand register of the arithmetic-logic unit, in alternation with accumulation instructions in respect of the operand register and the combined operand and result register of the arithmetic-logic unit,
the microprocessor extensions comprising:
buffers for storing sets of input data on which the MAc operation is to be performed; and
first communication buses for transferring input data from buffers into the operand registers of the multiplier,
wherein the first communication buses operate independently of the first clock signal.

2. A processor for performing a multiply-and-accumulate, MAc, operation, comprising:
a sequential arithmetic-logic unit, which operates synchronously with a first clock signal and is adapted to perform an accumulation instruction in respect of an operand register and a combined operand and result register;
a combinatorial multiplier comprising two operand registers and a result register;
a sequential bus operating synchronously with the first clock signal and connecting the result register of the combinatorial multiplier to the operand register of the arithmetic-logic unit; and
the microprocessor extensions of claim 1,
wherein the arithmetic-logic unit and the sequential bus are configured to perform a continuous sequence of transfers of intermediate product data from the result register of the multiplier to the operand register of the arithmetic-logic unit, in alternation with accumulation instructions in respect of the operand register and the combined operand and result register of the arithmetic-logic unit.

3. The device of claim 1, wherein the arithmetic-logic unit and the sequential bus are configured to perform the transfers and accumulation instructions in one-to-one alternation.

4. The device of claim 1, further comprising:
a finite state machine adapted to receive a signal indicating completion of an accumulation instruction and, based thereon, to control the communication buses in such manner that the operand register of the arithmetic-logic unit stores fresh intermediate product data at initiation of each accumulation instruction in the sequence.

5. The device of claim 4, wherein the finite state machine is operable in a normal mode and a low-power mode.

6. The device of claim 4, wherein the finite state machine is adapted to control the first communication buses by strobes.

7. The device of claim 4, wherein the finite state machine is a Mealy machine.

8. The device of claim 4, wherein the buffers and communication buses operate synchronously with a second clock signal, distinct from the first clock signal, wherein the frequency of the second clock signal is greater than or equal to the frequency of the first clock signal.

9. The device of claim 1, wherein a buffer is associated with buffer logic comprising:
a read pointer register to store an effective address reference to the memory location of the buffer from which data is read;
a modifier register to store an increment by which the read pointer register is modified between consecutive read operations; and
a data length register to control cyclic rotation which the incremental pointer register modifications are subjected to.

10. The device of claim 1, wherein the arithmetic-logic unit is a Z80 architecture.

11. The device of claim 1, wherein the finite state machine is adapted to receive a notification signal indicating that input data stored in a buffer have changed and, based thereon, to initiate a MAc operation.

12. The processor of claim 2, further adapted to respond to instructions in the group comprising:
and, compare, decrement, increment, load, multiply, or, subtract, shift, xor
by operating the arithmetic-logic unit independently and suppressing the buffers, communication buses and, if any, the finite state machine.

13. An implantable medical device including the processor of claim 2.

14. A method to perform a multiply-andaccumulate, MAc, operation by a sequential arithmetic-logic unit and a sequential second communication bus, which operate synchronously with a first clock signal,
the method comprising:
i) clearing a combined operand and result register of the arithmetic-logic unit;
ii) transferring input data from buffers into operand registers of a combinatorial multiplier using first communication buses operating independently of the first clock signal;
iii) transferring intermediate product data from a result register of the combinatorial multiplier into an operand register of an arithmetic-logic unit using the sequential second communication bus;
iv) performing an accumulation instruction in respect of the operand register and a combined operand and result register of the arithmetic-logic unit;
v) repeating steps ii), iii) and iv) until all input data have been processed,
wherein a continuous sequence of instances of step iii) in alternation with instances of step iv) is performed.

15. The method of claim 14, wherein a continuous sequence of instances of step iii) in one-to-one alternation with instances of step iv) is performed.

16. The method of claim 14, wherein the second communication bus when in continuous operation is adapted to initiate a transfer of intermediate product data in response to every N^{th} edge of the first clock signal,
the method comprising completing step ii) prior to an edge at which the second communication bus (N1) initiates a transfer.

17. The method of claim 14, wherein step ii) includes using communication buses operating synchronously with a second clock signal, distinct from the first clock signal, wherein the frequency of the second clock signal is greater than or equal to the frequency of the first clock signal.

18. The method of claim 14, wherein the arithmetic-logic unit is a Z80 architecture.

19. A data carrier storing computer-readable instructions for performing the method of claim 14.

20. Use of circuitry in a processor for performing a multiply-and-accumulate, MAc, operation, the circuitry comprising:
a sequential arithmetic-logic unit, which operates synchronously with a first clock signal and is adapted to perform an accumulation instruction in respect of an operand register and a combined operand and result register;
a combinatorial multiplier comprising two operand registers and a result register; and
a sequential bus operating synchronously with the first clock signal and connecting the result register of the combinatorial multiplier to the operand register of the arithmetic-logic unit,
wherein the arithmetic-logic unit and the sequential bus are configured to perform a continuous sequence of transfers of intermediate product data from the result register of the multiplier to the operand register of the arithmetic-logic unit, in alternation with accumulation instructions in respect of the operand register and the combined operand and result register of the arithmetic-logic unit,
wherein:
input data from buffers are transferred into operand registers of a combinatorial multiplier using first communication buses; and
the first communication buses operate independently of the first clock signal (CLK1).

21. Microprocessor extensions for cooperating with a sequential arithmetic-logic unit to perform a multiply-and-accumulate, MAc, operation,
wherein the arithmetic-logic unit operates synchronously with a first clock signal and is adapted to perform a continuous sequence of accumulation instructions in respect of an operand register and a combined operand and result register,
the microprocessor extensions comprising:
buffers for storing sets of input data on which the MAc operation is to be performed;
a combinatorial multiplier comprising two operand registers and a result register;
first communication buses for transferring input data from buffers into the operand registers of the multiplier; and
a second communication bus for transferring intermediate product data from the result register of the multiplier into the operand register of the arithmetic-logic unit,
wherein the buses operate independently of the first clock signal.

22. A processor for performing a multiply-and-accumulate, MAc, operation, comprising:
a sequential arithmetic-logic unit, which operates synchronously with a first clock signal and is adapted to perform a continuous sequence of accumulation instructions in respect of an operand register and a combined operand and result register, and
the microprocessor extensions of claim 21.

23. The device of claim 21, further comprising:
a finite state machine adapted to receive a signal indicating completion of an accumulation instruction and, based thereon, to control the communication buses in such manner that the operand register of the arithmetic-logic unit stores fresh intermediate product data at initiation of each accumulation instruction in the sequence.

24. The device of claim 23, wherein the finite state machine is further adapted to receive a signal from the multiplier indicating that intermediate product data are available in the result register and, based thereon, to control the second communication bus.

25. The device of claim 23, wherein the finite state machine is operable in a normal mode and a low-power mode.

26. The device of claim 23, wherein the finite state machine is adapted to control the first and second communication buses by strobes.

27. The device of claim 23, wherein the finite state machine is a Mealy machine.

28. The device of claim 23, wherein the buffers and communication buses operate synchronously with a second clock signal, distinct from the first clock signal, wherein the frequency of the second clock signal is greater than or equal to the frequency of the first clock signal.

29. The device of claim 21, wherein a buffer is associated with buffer logic comprising:
a read pointer register to store an effective address reference to the memory location of the buffer from which data is read;
a modifier register to store an increment by which the read pointer register is modified between consecutive read operations; and
a data length register to control cyclic rotation which the incremental pointer register modifications are subjected to.

30. The device of claim 21, wherein the arithmetic-logic unit is a Z80 architecture.

31. The device of claim 21, wherein the arithmetic-logic unit is further connected to the multiplier via an internal bus operating synchronously with the first clock signal.

32. The device of claim 21, wherein the finite state machine is adapted to receive a notification signal indicating that input data stored in a buffer have changed and, based thereon, to initiate a MAc operation.

33. The processor of claim 22, further adapted to respond to instructions in the group comprising:
and, compare, decrement, increment, load, multiply, or, subtract, shift, xor
by operating the arithmetic-logic unit independently and suppressing the buffers, communication buses and, if any, the finite state machine.

34. An implantable medical device including the processor of claim 22.

35. A method for performing a multiply-and-accumulate, MAc, operation by a sequential arithmetic-logic unit, which operates synchronously with a first clock signal and is adapted to perform a continuous sequence of accumulation instructions in respect of an operand register and a combined operand and result register,
the method comprising:
i) clearing the combined operand and result register;
ii) transferring input data from buffers into operand registers of a combinatorial multiplier using first communication buses;
iii) transferring intermediate product data from a result register of the combinatorial multiplier into the operand register of the arithmetic-logic unit using a second communication bus;
iv) repeating steps ii) and iii) until all input data have been processed; and
v) allowing the arithmetic-logic unit to complete the last accumulation instruction and extracting output data from the combined operand and result register,
wherein steps ii) and iii) include using communication buses operating independently of the first clock signal.

36. The method of claim 35, wherein the arithmetic-logic unit when in continuous operation is adapted to initiate an accumulation instruction in response to every N^{th} edge of the first clock signal,
the method comprising completing step iii) prior to an edge at which the arithmetic-logic unit initiates an accumulation instruction.

37. The method of claim 35, wherein step iv) comprises a first sub-step of
iv-1) polling the arithmetic-logic unit for a signal indicating completion of an accumulation instruction,
and a subsequent, second sub-step of
iv-2) repeating steps ii) and iii).

38. The method of claim 35, wherein steps ii) and iii) include using communication buses operating synchronously with a second clock signal, distinct from the first clock signal, wherein the frequency of the second clock signal is greater than or equal to the frequency of the first clock signal.

39. The method of claim 35, wherein the arithmetic-logic unit is a Z80 architecture.

40. A data carrier storing computer-readable instructions for performing the method of claim 35.

41. Use of a sequential arithmetic-logic unit, which operates synchronously with a first clock signal and is adapted to perform a continuous sequence of accumulation instructions in respect of an operand register and a combined operand and result register, in a processor for performing a multiply-and-accumulate, MAc, operation, wherein:
input data from buffers are transferred into operand registers of a combinatorial multiplier using first communication buses; and
intermediate product data from a result register of the combinatorial multiplier are transferred into the operand register of the arithmetic-logic unit using a second communication bus; and
the communication buses operate independently of the first clock signal.
